(19) United States
(12) Patent Application Publication
(10) Pub. No.: US 2007/0046914 A1
(43) Pub. Date: Mar. 1, 2007

(54) Field sequential display apparatus and drive method thereof

(75) Inventor: Young-ho Lee, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/497,274

(22) Filed: Aug. 2, 2006

(30) Foreign Application Priority Data
Aug. 29, 2005 (KR) 10-2005-0079445

(51) Int. Cl. G03B 27/00

(52) U.S. Cl. 355/51

(57) ABSTRACT

A field sequential display apparatus that dynamically drives a light source and a panel in response to an image signal and a method thereof are provided. A method of driving a light source of a field sequential display apparatus includes: reading predetermined image information from image signals based on power sources, respectively; controlling an irradiation time and applied voltage of each light source driven in respective image sub-fields based on the read image information; correcting the image signals based on light sources altered by the control of respective light sources; and displaying the corrected image signals on a panel based on a control signal of the corrected light sources.

### CROSS-REFERENCE TO RELATED PATENT APPLICATION

This application claims the benefit of Korean Patent Application No. 0-2005-0079445, filed on Aug. 29, 2005, in the Korean Intellectual Property Office, the disclosure of which is incorporated herein in its entirety by reference.

### BACKGROUND OF THE INVENTION

1. Field of the Invention

The present invention relates to a field sequential display apparatus, and more particularly, to a field sequential display apparatus that dynamically drives a light source and a panel in response to an image signal and a method thereof.

2. Description of the Related Art

In general, a liquid crystal display (LCD) apparatus includes upper and lower substrates, a liquid crystal panel which is composed of a liquid crystal infused between the upper and lower substrates, a driving circuit which drives the liquid panel, and a back light unit which provides white light onto the liquid crystal. Methods of implementing the liquid crystal display apparatus can be classified into a red, green and blue (RGB) color filter method and a color field sequential drive method according to a way of representing a color image.

In the color filter method, a pixel is divided into RGB unit pixels, RGB color filters are respectively arranged for the RGB unit pixels, and light is transferred to the RGB color filters by the back light unit, thereby forming a color image.

In the color field sequential drive method, RGB light sources are arranged for one pixel, and the RGB light sources of the RGB back light are sequentially displayed in a time division manner. At this time, one field is divided into several sub-fields based on a color and a driving speed. For a period of one field, that is, 16.7 ms, each color has an irradiation time and an applied voltage which are equivalent with each other or different based on default settings.

FIG. 1 is a view of a basic method of driving back light of a field sequential display apparatus according to the prior art.

Referring to FIG. 1, one image field is divided into RGB sub-fields to be displayed on a screen. Specifically, data R is first displayed on a liquid crystal panel, and a light source R is turned on after the liquid crystal is completely actuated. Light source R is then turned off. To display data G on the liquid panel, a light source G is turned on after the liquid crystal is completely actuated. Light source G is then turned off. To display data B on the liquid panel, a light source B is turned on after the liquid crystal is completely actuated. This sequence forms one screen of displayed data. However, the basic method of driving the back light of FIG. 1 has a short time for turning on the back light due to an image data input and response time of the liquid crystal, which leads to contrast deterioration. Therefore, to solve this problem, a drive method of using scrolling back light has been introduced.

FIG. 2 is a view of a drive method using scrolling back light of a field sequential image display apparatus according to the prior art.

Referring to FIG. 2, in the drive method using scrolling back light, a screen is divided into areas, and light sources are respectively driven for the areas. Namely, a light source is first driven for an area where the liquid crystal is completely actuated, and other color light sources are driven for other areas. The drive method using scrolling back light can have a greater time for turning on the light source than a basic drive method of the back light.

In the conventional method of FIGS. 1 and 2, the irradiation time of the back light is influenced by a predetermined initial value, which has the following problems.

In a field sequential panel driven by RGB back light, if an image is composed of only data R, light is blocked after the panel first passes light of the light source R. Then, according to the predetermined setting, the back light irradiates the light sources G and B. Such a drive method consumes power due to an unnecessary back light operation. In addition, if the back light continuously irradiates the light source R during the time light sources G and B are irradiated, color sense may not be fully represented on the panel. The same problems of power consumption and color sense also apply to a field sequential panel driven by red, green, blue, and white (RGBW) back light for a color break-up, when an input image is black and white. The above described two examples are extreme cases for clear understanding. However, there is a problem in that the capability of the panel may not be fully used even for common images.

### SUMMARY OF THE INVENTION

The present invention provides an apparatus for dynamically driving a light source of a field sequential display apparatus.

The present invention also provides a method of dynamically driving a light source of a field sequential display apparatus.

According to an aspect of the present invention, there is provided a method of driving a light source of a field sequential display apparatus including: reading predetermined image information from image signals based on power sources; controlling an irradiation time and applied voltage of each light source driven in respective image sub-fields based on the read image information; correcting the image signals based on light sources altered by the control of respective light sources; and displaying the corrected image signals on a panel based on a control signal of the corrected light sources.

According to another aspect of the present invention, there is provided a field sequential display apparatus including: an image decomposition unit decomposing an input image into an image signal corresponding to a light source based on a light source type; an image analysis unit analyzing an original image signal and each image signal decomposed by the image decomposition unit so as to read predetermined image information; a drive signal creation unit determining an irradiation time and applied voltage of a light source driven in each image sub-field based on image information analyzed by the image analyzing unit; a signal correction unit correcting the input image signal based on the image analysis information analyzed by the image analyzing unit and the light source altered by the drive signal creation unit; a field sequential display panel unit displaying the image signal corrected by the signal correction unit in accordance with a light source drive timing of the drive signal creation unit; and a light source drive unit driving the light source in accordance with a light timing of the field sequential display panel unit based on a light source drive control signal created by the drive signal creation unit.

### BRIEF DESCRIPTION OF THE DRAWINGS

The above and other aspects of the present invention will become more apparent by describing in detail exemplary embodiments thereof with reference to the attached drawings in which:

FIG. 1 is a view of a basic method of driving back light of a field sequential display apparatus according to the prior art;

FIG. 2 is a view of a drive method using scrolling back light of a field sequential image display apparatus according to the prior art;

FIG. 3 is an overall block diagram of a field sequential display apparatus according to an exemplary embodiment of the present invention;

FIG. 4 is a view of an image analysis unit of FIG. 3 according to an exemplary embodiment of the present invention;

FIG. 5 is a view of a drive signal creation unit according to an exemplary embodiment of the present invention;

FIGS. 6A and 6B are views of waveforms of a light source drive control signal for a conventional field sequential liquid crystal display (LCD);

FIGS. 7A and 7B are views of waveforms of a light source drive control signal for a voltage control of a drive signal creation unit of FIG. 3;

FIGS. 8A and 8B are views of waveforms of a light source drive control, in which an irradiation time is controlled by a drive signal creation unit;

FIGS. 9A and 9B are views of waveforms of a back light drive control signal, in which a voltage (or current) control and an irradiation time are both controlled by a drive signal creation unit of FIG. 3;

FIGS. 10A-10E are views of waveforms of a back light drive control signal of a drive signal creation unit of FIG. 3 in response to an input signal according to an exemplary embodiment of the present invention;

FIG. 11 is a view of waveforms of a light source drive control signal of a drive signal creation unit of FIG. 3 when a black and white image is input, according to an exemplary embodiment of the present invention; and

FIG. 12 is a flowchart of a method of driving a field sequential display apparatus according to an exemplary embodiment of the present invention.

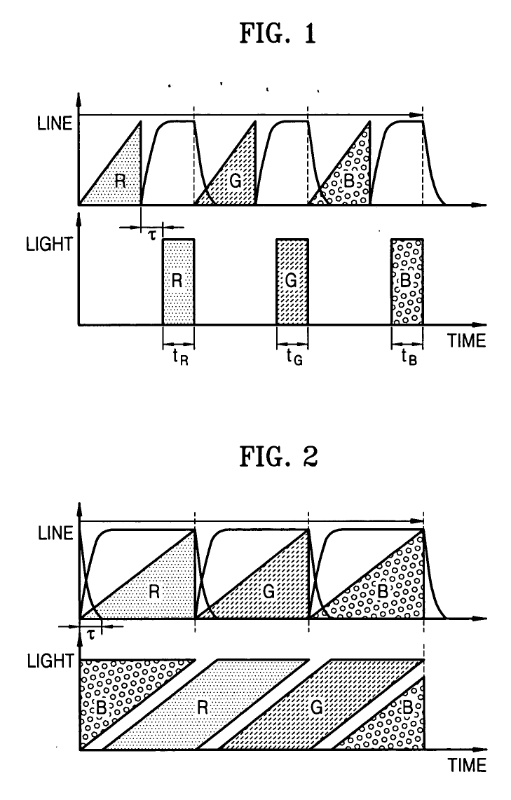

### DETAILED DESCRIPTION OF THE EXEMPLARY EMBODIMENTS

Hereinafter, exemplary embodiments of the present invention will be described in detail with reference to the accompanying drawings.

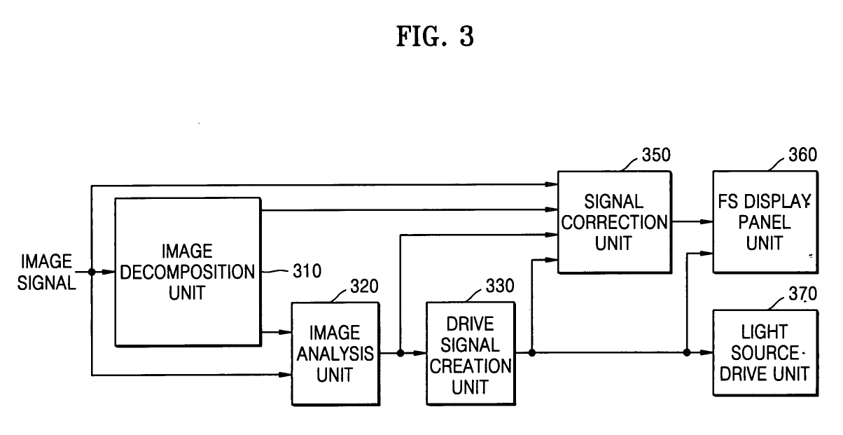

FIG. 3 is an overall block diagram of a field sequential display apparatus according to an exemplary embodiment of the present invention.

A field sequential image display apparatus of FIG. 3 includes an image decomposition unit 310, an image analysis unit 320, a drive signal creation unit 330, a signal correction unit 350, a field sequential (FS) liquid crystal display (LCD) panel unit 360, and a light source drive unit 370.

The image decomposition unit 310 decomposes an input image based on a light source type. For example, when the field sequential display apparatus uses a red, green and blue (RGB) drive method, an input image of various formats (for example, luma, chroma (YCbCr)) is converted into RGB signals through a color space conversion.

The image analysis unit 320 analyses various image information, such as motion, luminance, and ratio of each sub-field in one field, of the input image or the sub-fields decomposed by light sources in the image decomposition unit 310.

The drive signal creation unit 330 creates a light source drive control signal which controls a voltage or irradiation time of each light source driven in the sub-fields within one field using the image information obtained from the image analysis unit 320. For example, if the ratio of the sub-field G in one field is high, the drive signal creation unit 330 can control a voltage and irradiation time of the light source G. Of course, the voltage and irradiation time of each light source may be controlled based on an initial setting value set by a user.

The signal correction unit 350 corrects an image signal which is input in accordance with image analysis information of the image analysis unit 320, a user's preference setting value, and a light source altered using a light source drive control signal of the drive signal creation unit 330. Namely, as shown by mathematical expression 1, the signal correction unit 350 can correct image signals r, g, and b, which are input in accordance with original BL_{R}, BL_{G}, and BL_{B}, into image signals r′, g′, and b′ which are input in accordance with altered BL_{R}′, BL_{G}′, and BL_{B}′. The equation of the mathematical expression 1 may not be satisfied based on the user's preference.
r*BL_{R}+g*BL_{G}+b*BL_{B}=r′*BL_{R}′+g′*BL_{G}′+b″*BL_{B}′ [mathematical expression 1]

Here, BL denotes the amount of light.

The light source drive unit 370 drives light sources in accordance with a light timing of the panel in response to the light source drive control signal created by the drive signal creation unit 330.

The FS display panel unit 360 displays an image corrected by the signal correction unit 350 onto a liquid crystal panel in accordance with a drive timing of the drive signal creation unit 330.

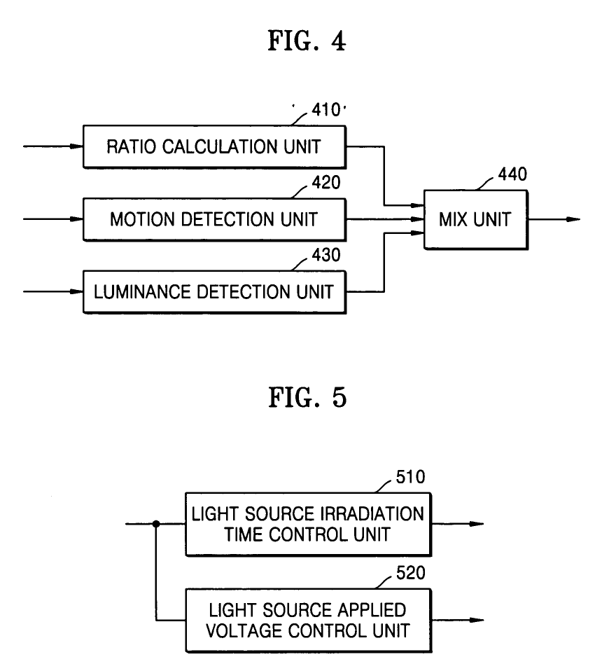

FIG. 4 is a view of the image analysis unit 320 of FIG. 3 according to an exemplary embodiment of the present invention.

Referring to FIG. 4, a ratio calculation unit 410 calculates ratios of each RGB signal within one field with respect to each RGB signal decomposed by the image decomposition unit 310, using a histogram.

A motion detection unit 420 detects motion information using motion estimation for an input image signal.

A luminance detection unit 430 detects luminance using a brightness histogram with respect to the input image data.

A mix unit 440 mixes image information which is respectively output from the ratio calculation unit 410, motion detection unit 420, and luminance detection unit 430.

FIG. 5 is a view of the drive signal creation unit 330 according to an exemplary embodiment of the present invention.

Referring to FIG. 5, a light source irradiation time control unit 510 controls on/off times of respective light sources by determining irradiation times of light sources based on image information analyzed by the image analysis unit 320.

A light source applied voltage control unit 520 controls brightness of each light source by determining applied voltages of respective light sources based on image information analyzed by the image analysis unit 320.

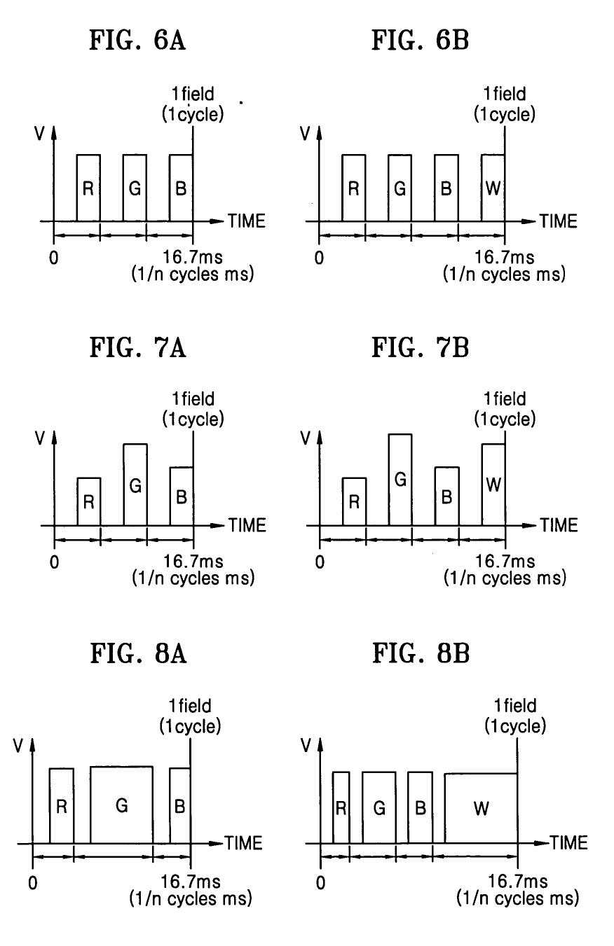

FIGS. 6A and 6B are views of waveforms of a light source drive control signal for a conventional field sequential LCD.

Referring to FIG. 6A, when a RGB back light drive is used, three RGB sub-fields are driven for the same time and with the same magnitude within one field. As shown by FIG. 6B, when a RGBW back light drive is used, the field is divided into four sub-fields within one field to drive the back light.

FIGS. 7A and 7B are views of waveforms of a light source drive control signal for a voltage control of the drive signal creation unit 330 of FIG. 3.

Referring to FIGS. 7A and 7B, when a specific color in an input image is desired to be emphasized, or a dominant light source or a minor light source is used, as shown by mathematical expression 2, the drive signal creation unit 330 can dynamically control light sources by increasing or decreasing a voltage (or current) with respect to a light source of a specific sub-field.
(BLV_{R}, BLV_{G}, BLV_{G}, BLV_{W})→(α*BLV′_{R}, β*BLV′_{G}, γ*BLV′_{B}, δ*BLV′_{W}) [mathematical expression 2]

Here, BLV is a back light voltage.

For example, as shown by FIG. 7A, the drive signal creation unit 330 decreases a voltage of a light source driven in the sub-field R, and increases a voltage of a light source driven in the sub-field G. In addition, as shown by FIG. 7B, the drive signal creation unit 330 increases a voltage of a light source driven in the sub-field W.

FIGS. 8A and 8B are views of waveforms of a light source drive control, in which an irradiation time is controlled by the drive signal creation unit 330.

The drive signal creation unit 330 controls irradiation times for respective light sources based on an analysis result of an input image as shown by mathematical expression 3.
¼*BLT_{R}+¼*BLT_{G}+¼*BLT_{B}+¼*BLT_{W}=a*BLT_{R}+b*BLT_{G}+c*BLT_{B}+d*BLT_{W}+e*BLT_{off} [mathematical expression 3]

Here, a+b+c+d+e equals 1 (cycle), and BLT denotes back light duration.

As shown by FIG. 8A, the drive signal creation unit 330 controls an irradiation time of a light source driven in the sub-field G. In addition, as shown by FIG. 8B, the drive signal creation unit 330 controls irradiation times of light sources driven in the sub-fields G and W.

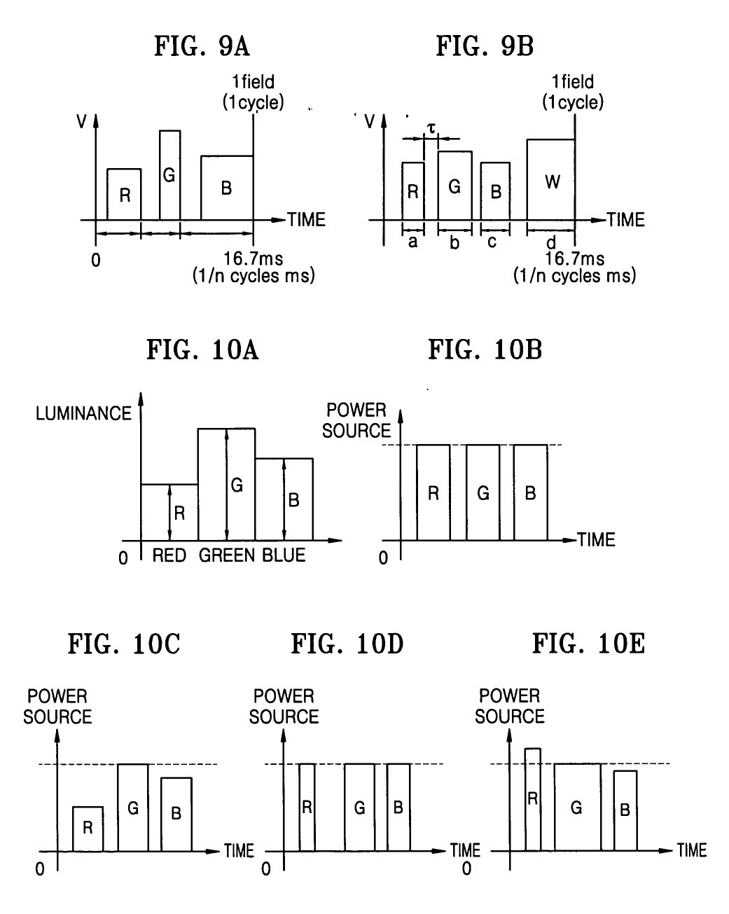

FIGS. 9A and 9B are views of waveforms of a back light drive control signal, in which a voltage (or current) control and an irradiation time are both controlled by the drive signal creation unit 330 of FIG. 3.

Referring to (FIGS. 9A and 9B, the drive signal creation unit 330 drives light sources of RGB sub-fields (or RGBW sub-fields) within one field by controlling both the voltage (or current) control and the irradiation time control based on each image information. Here, τ is a response time of the liquid crystal.

FIGS. 10A-10E are views of waveforms of a back light drive control signal of the drive signal creation unit 330 of FIG. 3 in response to an input signal according to an exemplary embodiment of the present invention.

Assuming that RGB ranges are obtained as a result of an analysis of an input image signal, as shown by FIG. 10A. In the prior art, a light source has been driven with a constant voltage and irradiation time regardless of the RGB ranges (shown by FIG. 10B). However, as shown by FIG. 10C, a light source drive method of the exemplary embodiments of the present invention can reduce power consumption by controlling a power source when the irradiation time is constant. Moreover, as shown by FIG. 10D, a drive method of the exemplary embodiments of the present invention can reduce power consumption by controlling an ‘ON’ time of a light source of a power source when the power source is constant. Last, as shown by FIG. 10E, in the drive method of the present invention, color luminance increases as a power source increases with respect to the light source of the sub-field R, thereby representing a full color sense. However, FIG. 10E shows that a color correction is needed in the drive method of the exemplary embodiments of the present invention.

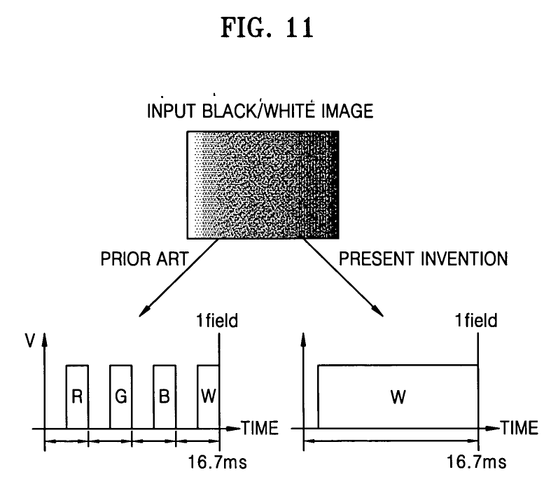

FIG. 11 is a view of waveforms of a light source drive control signal of the drive signal creation unit 330 of FIG. 3 when a black and white image is input, according to an exemplary embodiment of the present invention.

When the input image is black and white, in an apparatus using the RGBW drive, the conventional drive method displays the W sub-field on a screen during the period of ¼ field, with the RGB sub-fields being turned off, which leads to luminance deterioration. However, in the drive method of the exemplary embodiments of the present invention, luminance can be increased by displaying the W sub-field during the period of one field, with the RGB sub-fields being removed.

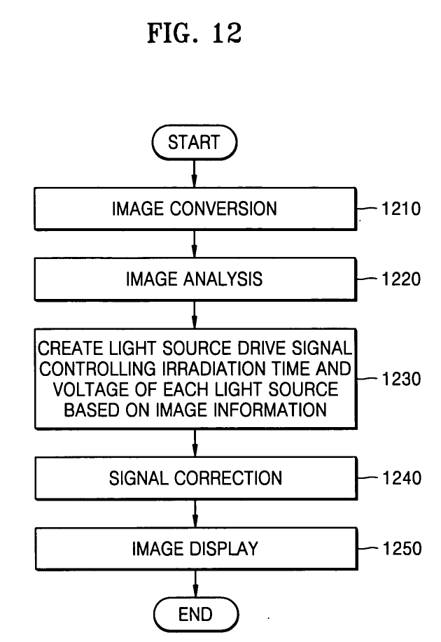

FIG. 12 is a flowchart of a method of driving a field sequential display apparatus according to an exemplary embodiment of the present invention.

First, an input image is converted into an image signal corresponding to a light source according to a light source type of a display apparatus (operation 1210).

Next, image information such as ratio of each sub-field, motion, and the like is read by analyzing an original image signal and the converted image signal (operation 1220).

Next, a drive signal that controls an irradiation time and applied voltage of each light source driven in each sub-field within a field is created according to the analyzed image information (operation 1230).

Next, an image signal which is input in accordance with the analyzed image analysis information and light source information altered by a light source control is corrected (operation 1240).

Next, a light source is driven in accordance with a light timing of a liquid crystal panel in response to a drive control signal, and the corrected image signal is displayed on the panel in accordance with the drive control timing (operation 1250).

Accordingly, in a field sequential display apparatus of the present invention, a dynamic range of each color is widened by controlling an irradiation time and driving voltage of each lamp for a back light unit (BLU) in response to an image signal, so that an image can be formed with a full color sense, and effectiveness of a display apparatus can be maximized. In addition, power consumption can be reduced since optimum power source is supplied to a light source based on the image signal.

In addition, the invention can be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

While the present invention has been particularly shown and described with reference to exemplary embodiments thereof, it will be understood by those skilled in the art that various changes in form and details may be made therein without departing from the spirit and scope of the present invention as defined by the appended claims.

What is claimed is:

1. A method of driving a light source of a field sequential display apparatus, the method comprising:
reading predetermined image information from image signals based on light sources;
controlling an irradiation time and applied voltage of each light source driven in respective image sub-fields based on the read image information;
correcting the image signals based on light sources altered by controlling respective light sources; and
displaying the corrected image signals on a display panel based on a control signal of the corrected light sources.

2. The method of claim 1, wherein the reading image information operation comprises:
decomposing an input image into an image signal corresponding to the light source based on a light source type; and
analyzing predetermined image information from the input image and the decomposed image signal.

3. The method of claim 2, wherein the analyzing the image information operation reads information of at least one of ratio of each sub-field in one field, motion, and luminance with respect to the input image signal and the decomposed image signals, respectively.

4. The method of claim 1, wherein the controlling an irradiation time and applied voltage of each light source operation determines on time, off time and luminance of each light source driven in a plurality of sub-fields within one field.

5. The method of claim 1, further comprising controlling an irradiation time and applied voltage of each light source driven in a plurality of image sub-fields in one field based on an initial setting value set by a user.

6. The method of claim 1, wherein the correcting the image signal operation corrects the image signals based on the image information and the light sources altered by the light source control.

7. The method of claim 1, wherein the correcting the image signal operation corrects the image signals based on the image information, a user preference setting value, and the light sources altered by the light source control.

8. A field sequential display apparatus comprising:
an image decomposition unit decomposing an input image into an image signal corresponding to a light source based on a light source type;
an image analysis unit analyzing an original image signal and each image signal decomposed by the image decomposition unit so as to read predetermined image information;
a drive signal creation unit determining an irradiation time and applied voltage of a light source driven in each image sub-field based on image information analyzed by the image analysis unit;
a signal correction unit correcting the input image signal based on the image analysis information analyzed by the image analysis unit and the light source altered by the drive signal creation unit;
a field sequential display panel unit displaying the image signal corrected by the signal correction unit in accordance with a light source drive timing of the drive signal creation unit; and
a light source drive unit driving the light source in accordance with a light timing of the field sequential display panel unit based on a light source drive control signal created by the drive signal creation unit.

9. The apparatus of claim 8, wherein the drive signal creation unit comprises:
a light source irradiation time control unit controlling an on time and an off time of each light source based on image information analyzed by the image analysis unit; and
a light source applied voltage control unit controlling brightness of each light source based on image information analyzed by the image analysis unit.

10. The apparatus of claim 9, wherein the drive signal creation unit further comprises an element determining an irradiation time and applied voltage of each light source based on an initial setting value set by a user.
